(19) United States
(12) Patent Application Publication
(10) Pub. No.: US 2014/0165516 A1
(43) Pub. Date: Jun. 19, 2014

(54) FILTER ELEMENT, FILTER SYSTEM COMPRISNG SUCH ELEMENT, METHODS OF MAKING AND USING SUCH ELEMENT AND SYSTEM

(71) Applicant: JONELL, INC., Breckenridge, OK (US)

(72) Inventors: ALAN L. CLARKE, Mineral Wells, TX (US); Schuyler Smith, Mineral Wells, TX (US)

(21) Appl. No.: 13/717,980

(22) Filed: Dec. 18, 2012

(51) Int. Cl. B01D 46/24; B01D 46/00

(52) U.S. Cl. CPC B01D 46/2414; B01D 46/0001
USPC 55/484; 55/498; 29/428

(57) ABSTRACT

A filter system that includes a filter element having an opening and an annular shaped sealing lip surrounding the opening. The system includes an end cap engaging and covering the opening, having an annular shaped sealing edge engaging the sealing lip, and having a parallel sided cylindrical guide portion positioned within the opening, and having an elongated cavity portion having a non-threaded first portion and a threaded second portion.

### BACKGROUND OF THE INVENTION

1. Field of the Invention

The present invention relates to filtering methods, apparatus and products. In another aspect, the present invention relates to filtering methods, apparatus and products for filtering particulates from gas. In even another aspect, the present invention relates to an end cap for securing an elongated filter element, and to methods and products for securing such an elongated filter element.

2. Brief Description of the Related Art

The processing of natural gas commonly involves a number of processing steps that are necessary for the gas to meet the quality standards specified by the major pipeline transmission and distribution companies. Those quality standards vary from pipeline to pipeline and are usually a function of a pipeline system's design and the markets that it serves.

As examples, the standards may specify that the natural gas (1) be within a specific range of heating value (caloric value); (2) be delivered at or above a specified hydrocarbon dew point temperature; (3) be free of particulate solids and liquid water to prevent erosion, corrosion or other damage to the pipeline; (4) be dehydrated of water vapor sufficiently to prevent the formation of methane hydrates within the gas processing plant or subsequently within the sales gas transmission pipeline; (5) contain no more than trace amounts of components such as hydrogen sulfide, carbon dioxide, mercaptans, and nitrogen; (6) maintain mercury at less than detectable limits (approximately 0.001 ppb by volume) primarily to avoid damaging equipment in the gas processing plant or the pipeline transmission system from mercury amalgamation and embrittlement of aluminum and other metals.

The removal of particulate solids may be accomplished by the use of a dry gas particulate filter system. Commonly, such a particulate filter system will include an elongated vertical vessel, in which are contained a plurality of hollow elongated filter elements (may also be referred to as cartridges) are arranged in parallel fashion. Each of these filter elements are placed over a threaded rod. This rod may be directly anchored to the vessel, or it may anchored to the top of another elongated rod member that is in turn anchored to the vessel. Generally, an end-cap is placed on the top end of the filter element, with the threaded rod extending through a hole in the middle of the end-cap. A washer and two nuts are then utilized to secure the end-cap on the filter element and thereby secure the filter element onto the threaded rod. Two nuts are generally to reduce the chance of operational vibrations from loosening the filter element.

One of the issues that arise with this arrangement is that the seal between the end-cap and the end is not always sufficient to prevent particulate from by passing the filter.

Another issue that arises with this arrangement is the complication and the amount of time that it takes to install/remove a filter element.

A related issue that arises is the complication that any dropped pieces (such as a washer or nut) into the filter equipment are extremely difficult to retrieve, and have the potential to cause catastrophic damage to the equipment if not retrieved.

Certainly, none of the steps of removing the old filter element and installation of the new filter element would at first glance appear to be too complex or too time consuming. But consider, (1) these steps may be carried out under limited space conditions, (2) these steps may be carried out in harsh environmental or weather conditions that distract from worker concentration, (3) dropping any items into the filter vessel may create a retrieval nightmare, (4) there is a certain amount of skill required to quickly install/remove filter elements; and (5) as there are numerous filter elements, a few extra minutes on each filter is magnified. To even further complicate matters, (6) these steps may be carried out wearing bulky personal safety equipment including thick gloves, bulky protective suits that restrict movement, headgear that may restrict movement, eyewear that may distort vision, and the like,

Removal of the filter element may include: (1) removal of the first nut, (2) removal of the second nut, (3) removal of one or more washers, (4) removal of the end cap, and (5) removal of the filter element from the threaded rod and away from the vessel. Installation of a new filter element may include: (1) positioning the filter element on the threaded rod, (2) placing the end-cap on the top end of the filter element with the threaded rod extending through the hole in the middle of the end cap, and making sure the end cap is centered on the filter element, (3) placing one or more washers on the threaded rod, (4) threading the first nut on the threaded rod and tightening to secure the end cap, (5) threading the second nut on the threaded rod, and (6) making sure the end cap stays positioned and does not “walk” off during tightening.

Again, none of the steps of removing the old filter element and installation of the new filter element would at first glance appear to be too complex or too time consuming. To further illustrate, handling the small washers and nuts is time consuming at best with bare hands, and with gloved hands becomes more difficult.

Any washers or nuts that are dropped may fall to the bottom of the filter vessel and may be well beyond arms length, and once on the floor of the vessel are small enough to be visually obscured by debris. Retrieval of any dropped items may be quite time consuming, and any items that are left dropped may be buffeted by the gas flow and may cause damage to the vessel and filters. Experience shows that it is not uncommon for these dropped items to be left in the vessel. Positioning the end cap onto the threaded rod takes skill with bare or gloved hands, and so does centering the end cap on the filter element.

There is a need in the art for methods, apparatus and products for filtering.

There is another need in the art for methods, apparatus and products for filtering that address the issues that arise with this arrangement is that the seal between the end-cap and the end is not always sufficient to prevent particulate from by passing the filter.

There is even another need in the art for methods, apparatus and products for filtering that addresses issues that arises with this arrangement is the complication and the amount of time that it takes to install/remove a filter element.

There is still another need in the art for methods, apparatus and products for filtering that addresses that arises is the complication that any dropped pieces (such as a washer or nut) into the filter equipment are extremely difficult to retrieve, and have the potential to cause catastrophic damage to the equipment if not retrieved.

These and other needs in the art will become apparent to those of skill in the art upon review of this specification, including its drawings and claims.

### SUMMARY OF THE INVENTION

It is an object of the present invention to provide for methods, apparatus and products for filtering.

There is another object of the present invention to provide for methods, apparatus and products for filtering that address the issues that arise with this arrangement is that the seal between the end-cap and the end is not always sufficient to prevent particulate from by passing the filter.

There is even another object of the present invention to provide for filtering that addresses issues that arises with this arrangement is the complication and the amount of time that it takes to install/remove a filter element.

There is still another object of the present invention to provide for filtering that addresses that arises is the complication that any dropped pieces (such as a washer or nut) into the filter equipment are extremely difficult to retrieve, and have the potential to cause catastrophic damage to the equipment if not retrieved.

These and other objects of the present invention will become apparent to those of skill in the art upon review of this specification, including its drawings and claims.

According to one embodiment of the present invention, there is provided a filter system that may include an elongated hollow tubular filter element with a top end defining an opening of a first diameter, the top end having a flat annular shaped sealing lip surrounding the opening. The filter system may also include an end cap engaging and covering the opening, having an annular shaped sealing edge engaging the sealing lip, and having a parallel sided cylindrical guide portion positioned within the opening, and having an elongated cavity portion having a non-threaded first portion and a threaded second portion.

According to another embodiment of the present invention, there is provided a filter system that may include a vessel having a plurality of risers positioned therein, with the risers each having a first threaded end. The filter system may include a plurality of elongated hollow tubular filter elements each having a top end defining an opening of a first diameter, the top end having a flat annular shaped sealing lip surrounding the opening, with each filter element positioned on a riser with the riser extending through the filter element with the threaded end extending out through the opening. The filter system may also include an end cap engaging and covering the opening, having an annular shaped sealing edge engaging the sealing lip, and having a parallel sided cylindrical guide portion positioned within the opening, and having an elongated cavity portion engaging the threaded end, with the elongated cavity portion having a non-threaded first portion and a threaded second portion.

According to even another embodiment of the present invention, there is provided a method of positioning an elongated hollow tubular filter element within a filter vessel having risers therein, and with the risers each having a first threaded end. The method may include positioning the elongated hollow tubular filter element on at least one of the risers, wherein the filter element comprises a top end defining an opening of a first diameter, the top end having a flat annular shaped sealing lip surrounding the opening, with each filter element positioned on a riser with the riser first threaded end extending through the filter element and out through the opening. The method may also include positioning an end cap on the opening, wherein the end cap comprises an annular shaped sealing edge, comprises a parallel sided cylindrical guide portion, and comprises an elongated cavity portion having a non-threaded first portion and a threaded second portion, wherein positioning the end cap comprises covering the opening with the end cap, engaging the sealing edge with the sealing lip, positioning the riser first threaded end in the elongated cavity portion and engaged the threaded end and the threaded second portion.

According to still another embodiment of the present invention there is provided a method of positioning an end cap on a filter element, wherein the filter element is positioned within a filter vessel having riser elements therein with the risers each having a first threaded end, and wherein the filter element comprises a top end defining an opening of a first diameter, the top end having a flat annular shaped sealing lip surrounding the opening, with each filter element positioned on a riser with the riser first threaded end extending through the filter element and out through the opening. The method may include positioning an end cap on the opening, wherein the end cap comprises an annular shaped sealing edge, comprises a parallel sided cylindrical guide portion, and comprises an elongated cavity portion having a non-threaded first portion and a threaded second portion, wherein positioning the end cap comprises covering the opening with the end cap, engaging the sealing edge with the sealing lip, positioning the riser first threaded end in the elongated cavity portion and engaged the threaded end and the threaded second portion.

These and other embodiments of the present invention will become apparent to those of skill in the art upon review of this specification, including its drawings and claims.

### BRIEF DESCRIPTION OF THE DRAWINGS

The following drawings illustrate some of the many possible embodiments of this disclosure in order to provide a basic understanding of this disclosure. These drawings do not provide an extensive overview of all embodiments of this disclosure. These drawings are not intended to identify key or critical elements of the disclosure or to delineate or otherwise limit the scope of the claims. The following drawings merely present some concepts of the disclosure in a general form. Thus, for a detailed understanding of this disclosure, reference should be made to the following detailed description, taken in conjunction with the accompanying drawings, in which like elements have been given like numerals.

FIG. 1 is a drawing showing the top portion of a plurality of filter elements 11 positioned within a vertical vessel, and positioned over vertical rod member 17 having a threaded rod end member 18 attached thereto.

FIG. 2 is a schematic representation showing filter element 11 and threaded rod 18, and prior art end cap 19, prior art washer 21, and prior art nuts 22.

FIG. 3 is a drawing of showing a plurality of filter elements 11 secured in position in vertical filtration vessel 14.

FIG. 4 is a schematic showing end cap 20 of the present invention, along with filter element 11 and threaded rod 18.

FIG. 5 is a drawing showing a plurality of end caps 20 securing filter elements 11 in position in the filtration vessel.

FIG. 6 is a drawing showing a plurality of end caps 19 securing filter elements 11 in position in the filtration vessel, and for contrast, a single end cap 20 securing a filter element 11.

### DETAILED DESCRIPTION OF THE INVENTION

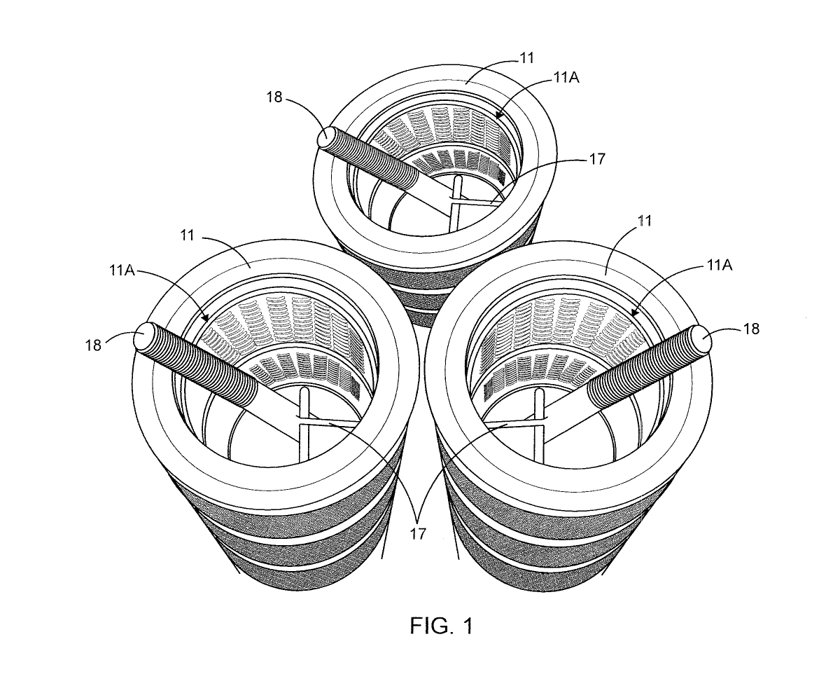

Referring now to FIGS. 1, 2 and 3, there are shown a plurality of filter elements 11 positioned within a vertical vessel 14.

FIG. 1 is a drawing showing the top portion of a plurality of filter elements 11 positioned within a vertical vessel, and positioned over riser or vertical rod member 17 having a threaded rod end member 18 attached thereto. A plurality of risers 17 may each be anchored to the bottom of the vessel, and may include an integral threaded end, or a discrete threaded rod end member 18. Riser 17 will include a lower plate (not shown) on which filter element rests and forms a seal.

Filter element 11 is a hollow elongated tubular member and may comprise a top end having an opening 11A of a first diameter. Part or all of the side walls may comprise filter material. Filter element 11 may also comprise a sealing lip 11B having an annular shape and extending circumferentially around opening 11A as shown in FIG. 1.

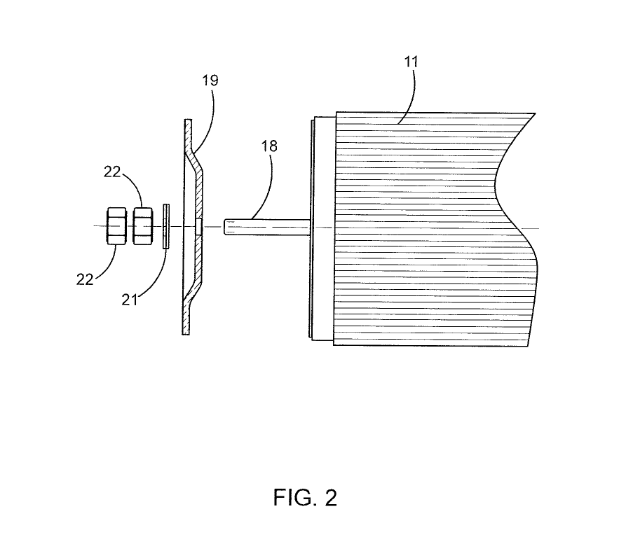

FIG. 2 is a schematic representation showing filter element 11 and threaded rod 18, and prior art end cap 19, prior art washer 21, and prior art nuts 22. In such prior art installation, filter element 11 is placed over threaded rod 18, then end cap 19 is positioned over filter element 11 with threaded rod 18 extending through end cap 19, then one or more washers 21 are positioned onto threaded rod 18, and finally, the first and then second nuts 22 are threaded onto threaded rod 18 and tightened. In such prior art removal, the first and then second washers 22 are unthreaded from threaded rod 18, then the one or more washers 21 are removed from threaded rod 18, then end cap 19 is removed, and finally filter element 11 is removed. If prior art end cap 19 moved off center, sloped portion 19B may all end cap 19 to more easily “walk off” from its position.

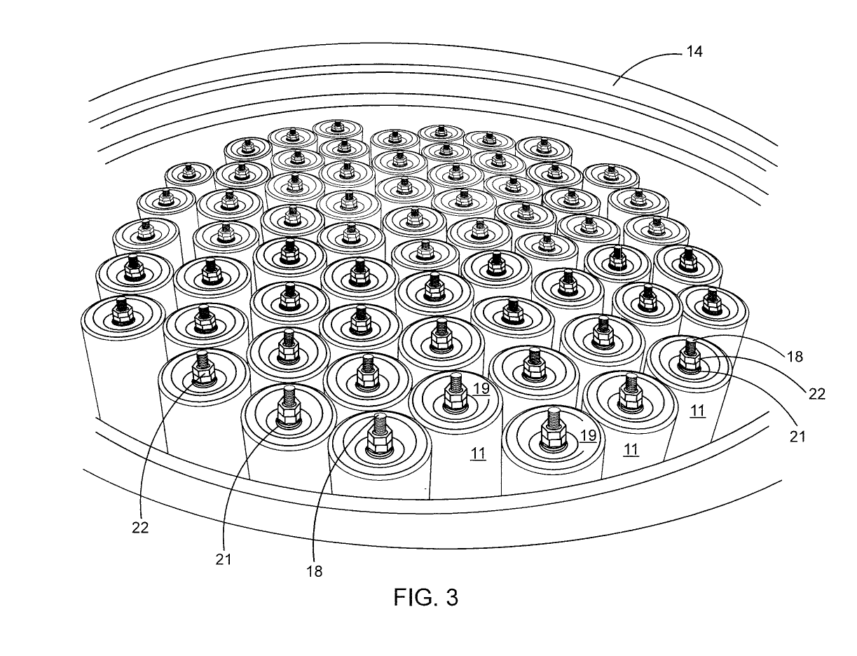

FIG. 3 is a drawing of showing a plurality of filter elements 11 secured in position in vertical filtration vessel 14. End cap 19 is positioned in place on the top of filter 11, with threaded rod 18 extending there through, with washers 21 placed and nuts 22 tightened thereon.

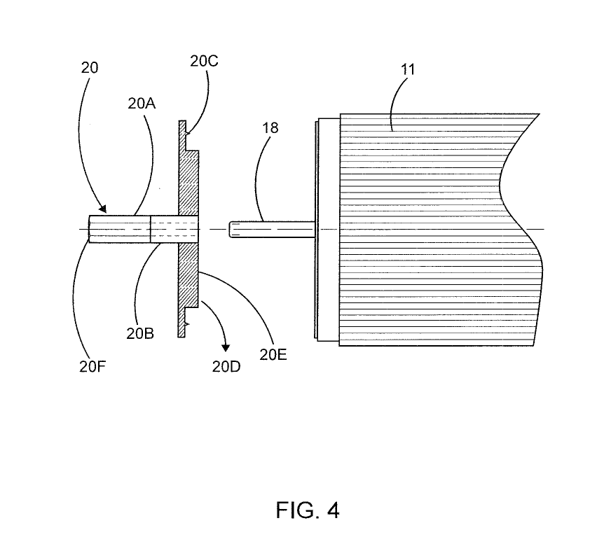

Referring additionally to FIG. 4, there is shown end cap 20 of the present invention, along with filter element 11 and threaded rod 18. This end cap 20 may be utilized to replace at least one if not all of prior art end cap 19, washers 21, and nuts 22.

End cap 20 may include a sealing surface 20C extending circumferentially around the bottom of end cap 20 and designed to engage and form a seal with sealing lip 11B at the top of filter element 11, or any gasket interposed between filter element 11 and end cap 20. A suitable type of sealing surface 20C may include a “knife edge” 20G that extends circumferentially around end cap 20. In operating, this sealing surface 20C not only forms a seal, it also provides some amount of resistant to end cap 20 walking away from its position on filter element 11.

End cap 20 may include a self-centering guide portion 20D on the bottom of end cap 20 for engaging opening 11A in the top of filter element 11. This self-centering guide portion is sized slightly smaller than filter element opening 11A and is centered within the annularly shaped sealing surface 20C and promotes the centering of end cap 20 onto filter opening 11A. Self-centering guide has an outer wall 20H extending radially around that serves to engage the walls of opening 11A.

The fit between self-centering guide portion 20D and filter element opening 11A should not be too tight or it may become too difficult to align and engage the two. On the other hand, too loose of a fit may make it more difficult to engage properly. The fit between guide portion 20D and the walls of opening 11A may be described as a light fit. Generally there must be enough play in the fit to allow ease of engagement between portion 20D and opening 11A, but not so much as to make alignment of threaded rod 18 with end cap portions 20A/20B too difficult. This self-centering guide portion may also include at least one portion 20H that is of constant diameter (that is, a regular parallel sided cylindrical portion) to help resist/restrict any “walk-off” of end cap 20 once it is placed on filter 11. For example, the prior art plate as shown in FIG. 2 has a tapered section 19B that tends to encourage/allow “walk-off” of end cap 19. Another way to describe this constant diameter portion is to view the side walls 20H of that portion as appearing “parallel” as shown in FIG. 4 rather than “tapered” as shown in FIG. 2.

End 20F of end cap 20 may be open, plugged, or made integrally sealed. If end 20F is plugged or sealed, the length of riser 17/threaded rod 18 becomes important and must be sized suitable for the vessel and filter element. If end 20F is open, then end cap 20 may be tightened down upon filter 11 with less concern for the length of riser 17/threaded rod 18.

End cap 20 may include a threaded portion 20A that is complimentary to threaded rod 18. End cap 20 may further include a non-threaded guide portion 20B that is sized to easily receive threaded rod 18 and guide this rod 18 toward engagement with threaded portion 20A, that is, non-threaded guide portion 20B has a diameter larger than rod 18 to allow ease of insertion. While non-threaded guide portion 20B is shown as a parallel shaped tubular passage, it should be understood that any suitable shape may be utilized, including any shapes that taper or reduce down in size approaching the threaded portion 20A. In operation this non-threaded guide portion 20B is placed over threaded rod 18 and easily permits engagement of rod 18 with end cap threaded portion 20A. Suitable rotation of end cap 20 secures end cap 20 against filter element 11, with knife edge 20C engaging and sealing against filter element 11 or any gasket interposed therebetween.

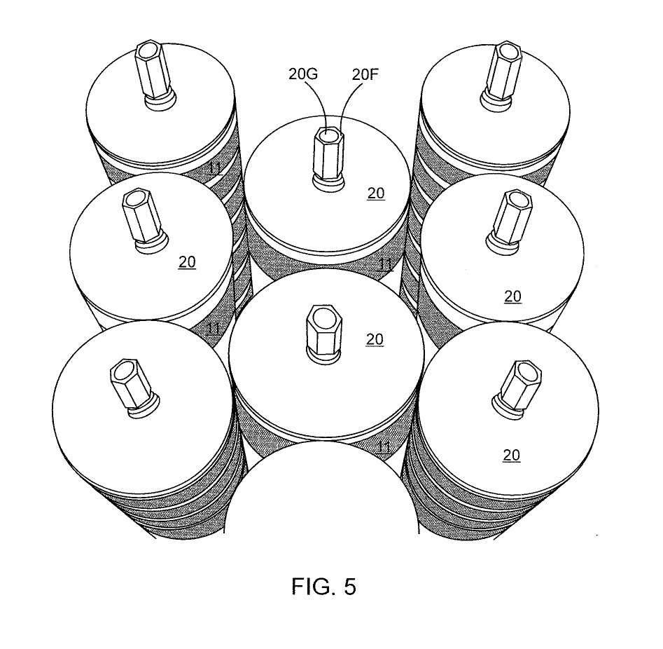

Referring additionally to FIG. 5 there is shown a plurality of end caps 20 securing filter elements 11 in position in the filtration vessel. In the embodiment as shown, end caps 20 further include sealed end 20F.

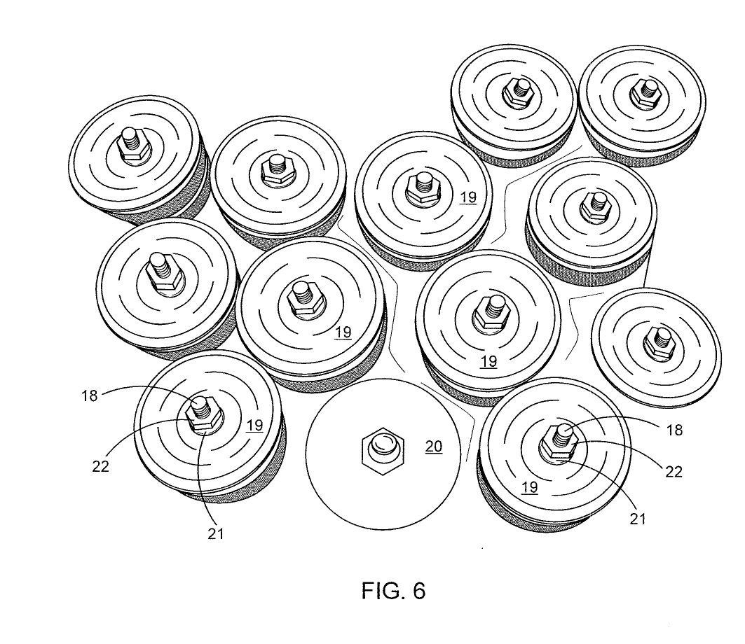

Referring additionally to FIG. 6 there is a drawing showing a plurality of end caps 19 securing filter elements 11 in position in the filtration vessel, and for contrast, a single end cap 20 securing a filter element 11.

The present disclosure is to be taken as illustrative rather than as limiting the scope or nature of the claims below. Numerous modifications and variations will become apparent to those skilled in the art after studying the disclosure, including use of equivalent functional and/or structural substitutes for elements described herein, use of equivalent functional couplings for couplings described herein, and/or use of equivalent functional actions for actions described herein. Any insubstantial variations are to be considered within the scope of the claims below.

1. A filter system comprising,
(a) an elongated hollow tubular filter element with a top end defining an opening of a first diameter, the top end having a flat annular shaped sealing lip surrounding the opening; and,
(b) an end cap engaging and covering the opening, having an annular shaped sealing edge engaging the sealing lip, and having a parallel sided cylindrical guide portion positioned within the opening, and having an elongated cavity portion having a non-threaded first portion and a threaded second portion.

2. The system of claim 1, wherein the sealing edge further includes a knife edge for engaging the sealing lip.

3. A filter system comprising,
(a) a vessel having a plurality of risers positioned therein, with the risers each having a first threaded end;
(b) a plurality of elongated hollow tubular filter elements each having a top end defining an opening of a first diameter, the top end having a flat annular shaped sealing lip surrounding the opening, with each filter element positioned on a riser with the riser extending through the filter element with the threaded end extending out through the opening; and,
(c) an end cap engaging and covering the opening, having an annular shaped sealing edge engaging the sealing lip, and having a parallel sided cylindrical guide portion positioned within the opening, and having an elongated cavity portion engaging the threaded end, with the elongated cavity portion having a non-threaded first portion and a threaded second portion.

4. The system of claim 3, wherein the sealing edge further includes a knife edge for engaging the sealing lip.

5. A method of positioning an elongated hollow tubular filter element within a filter vessel having riser elements therein, with the risers each having a first threaded end, the method comprising:
(a) positioning the elongated hollow tubular filter element on at least one of the risers, wherein the filter element comprises a top end defining an opening of a first diameter, the top end having a flat annular shaped sealing lip surrounding the opening, with each filter element positioned on a riser with the riser first threaded end extending through the filter element and out through the opening; and,
(b) positioning an end cap on the opening, wherein the end cap comprises an annular shaped sealing edge, comprises a parallel sided cylindrical guide portion, and comprises an elongated cavity portion having a non-threaded first portion and a threaded second portion, wherein positioning the end cap comprises covering the opening with the end cap, engaging the sealing edge with the sealing lip, positioning the riser first threaded end in the elongated cavity portion and engaged the threaded end and the threaded second portion.

6. The method of claim 5, wherein the sealing edge further includes a knife edge for engaging the sealing lip.

7. A method of positioning an end cap on a filter element, wherein the filter element is positioned within a filter vessel having riser elements therein with the risers each having a first threaded end, and wherein the filter element comprises a top end defining an opening of a first diameter, the top end having a flat annular shaped sealing lip surrounding the opening, with each filter element positioned on a riser with the riser first threaded end extending through the filter element and out through the opening, the method comprising:
(a) positioning an end cap on the opening, wherein the end cap comprises an annular shaped sealing edge, comprises a parallel sided cylindrical guide portion, and comprises an elongated cavity portion having a non-threaded first portion and a threaded second portion, wherein positioning the end cap comprises covering the opening with the end cap, engaging the sealing edge with the sealing lip, positioning the riser first threaded end in the elongated cavity portion and engaged the threaded end and the threaded second portion.

8. The method of claim 7, wherein the sealing edge further includes a knife edge for engaging the sealing lip.
